(19) United States
(12) Patent Application Publication
(10) Pub. No.: US 2009/0132489 A1
(43) Pub. Date: May 21, 2009

(54) METHOD FOR MANAGING DIGITAL PHOTOGRAPH, APPARATUS FOR DISPLAYING DIGITAL PHOTOGRAPH, AND METHOD FOR PLAYING THE SAME

(75) Inventor: Jian-Lin LI, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: TRANSCEND INFORMATION , INC., Taipei (TW)

(21) Appl. No.: 12/018,807

(22) Filed: Jan. 24, 2008

(30) Foreign Application Priority Data
Nov. 15, 2007 (TW) 96143268

(51) Int. Cl. G06F 17/30; G09G 3/36

(52) U.S. Cl. 707/3; 345/87; 707/100; 707/E17.009; 707/E17.014

(57) ABSTRACT

A method for playing a digital photograph display apparatus is provided. The method includes connecting the digital photograph display apparatus to a storage area, wherein the storage area has a plurality of digital photographs. In this method, a metadata (for example, the information in an exchange image file—EXIF), of each digital photograph is captured to read the corresponding shooting date of the digital photograph. In addition, a current date information is generated. The corresponding shooting date of each digital photograph is compared with the current date information. A digital photograph is displayed when the shooting date of the digital photograph is related to the current date information.

### CROSS-REFERENCE TO RELATED APPLICATION

This application claims the priority benefit of Taiwan application serial no. 96143268, filed on Nov. 15, 2007. The entirety of the above-mentioned patent application is hereby incorporated by reference herein and made a part of this specification.

### BACKGROUND OF THE INVENTION

1. Field of the Invention

The present invention generally relates to a method for managing digital photographs, an apparatus for displaying digital photographs, and a method for playing the apparatus, in particular, to a method for managing digital photographs, an apparatus for displaying digital photographs, and a method for playing the apparatus by using metadata.

2. Description of Related Art

Photograph is a very important medium for recording memories. Conventional photographs are created by exposing and developing photo-sensitive films. Conventional photographs are difficult to be preserved (for example, they have to be kept under suitable humidity and temperature) or sorted since they are made of paper.

With the development of digital techniques, today's photographs can be converted into and saved as digital files. For example, a photograph can be scanned and saved as a digital file by using a scanner, or a digital photograph can be directly created by using a digital camera. The preservation of photographs is no more a difficult job because of the invention of digital photograph technique. For example, thousands of digital photographs can be saved in a single optical disk. Accordingly, the photographs can be easily copied and the quality thereof will never wear off. Moreover, along with the advancement of digital image processing software, edit of digital photographs is made very flexible.

Because of the digitalization of photographs, apparatus for displaying digital photographs is also invented, such as a digital photo frame. Unlike a conventional frame that can only display limited number of photographs, a digital photo frame can display different number of photographs according to the capacity of the storage unit therein. Thus, a digital photo frame can be used for displaying a large number of photographs according to the specification set by a user. Moreover, the price of digital photo frame has become very acceptable due to the advancement of semiconductor and display panel fabrication processes.

Even though digital photographs are much easier to be preserved and edited compared to the conventional photographs, they are still difficult to be sorted. If a user wants to display a large number of digital photographs in a digital photo frame, the user still needs to spend a lot of time on sorting and setting these digital photographs so that the digital photographs can be displayed in the digital photo frame according to the requirement of the user, which is very time-consuming and may limit the widespread of digital photo frame.

### SUMMARY OF THE INVENTION

Accordingly, the present invention is directed to a method for managing digital photographs, wherein the digital photographs are automatically categorized.

The present invention is directed to a method for playing a digital photograph display apparatus, wherein suitable digital photographs are automatically selected and displayed.

The present invention is directed to an apparatus for displaying digital photographs, wherein the digital photographs are automatically categorized and selected digital photographs are displayed.

The present invention provides a method for managing a digital photograph. In this method, a header information of the digital photograph is captured, and whether the header information conforms to a predetermined condition is determined. The digital photograph is set as a displaying digital photograph when the header information conforms to the predetermined condition.

The present invention provides a method for playing a digital photograph display apparatus. The method includes connecting the digital photograph display apparatus to a storage area including external or internal storage areas, wherein the storage area has a plurality of digital photographs. Additionally, in this method, a header information of each digital photograph is compared with a predetermined condition, and a digital photograph is captured form the storage area to be displayed if the header information thereof conforms to the predetermined condition.

According to an embodiment of the present invention, the header information of the digital photograph is a metadata of the digital photograph.

According to an embodiment of the present invention, the step of comparing the header information with the predetermined condition includes: generating a current date information; reading a corresponding shooting date from the metadata of each digital photograph; and comparing the shooting date of each digital photograph with the current date information, wherein it is determined that the digital photograph conforms to the predetermined condition when the shooting date of the digital photograph is related to the current date information, and it is determined that the digital photograph does not conform to the predetermined condition when the shooting date of the digital photograph is not related to the current date information.

The present invention provides a digital photograph display apparatus including a storage unit, a display unit, and a control unit. The storage unit stores a plurality of digital photographs. The display unit displays images. The control unit is coupled to the storage unit and the display unit. The control unit captures a header information of each digital photograph and displays a digital photograph through the display unit if the header information of the digital photograph conforms to a predetermined condition.

According to an embodiment of the present invention, the digital photograph display apparatus may further include a timing unit for providing a current date information to the control unit. The control unit compares the corresponding shooting date of each digital photograph with the current date information and displays a digital photograph through the display unit if the shooting date of the digital photograph is related to the current date information.

According to another embodiment of the present invention, the digital photograph display apparatus may further include a transmission interface unit which connects the control unit to a remote server via a data transmission path, wherein the remote server stores a plurality of digital photographs. Accordingly, the control unit can download digital photographs from the remote server via the data transmission path and display the digital photographs through a display unit, wherein the header information of the digital photographs conforms to the predetermined condition.

In the present invention, digital photographs are displayed according to the header information thereof so that a user does not need to set the digital photographs, and accordingly the time for setting the digital photographs is saved. Moreover, in the present invention, digital photographs are automatically displayed on a date related to their shooting date. Accordingly, the commercial value of the digital photograph display apparatus is further increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a digital photograph display apparatus according to a first embodiment of the present invention.

FIG. 2 is a diagram illustrating the data stored in a storage unit in FIG. 1.

FIG. 3 is a diagram of the exchangeable image file (EXIF) format.

FIG. 4 is a flowchart illustrating a digital photograph management method according to an embodiment of the present invention.

FIG. 5 is a block diagram illustrating the function of a digital photograph display apparatus according to a second embodiment of the present invention.

FIG. 6 is a block diagram illustrating the function of a digital photograph display apparatus according to a third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

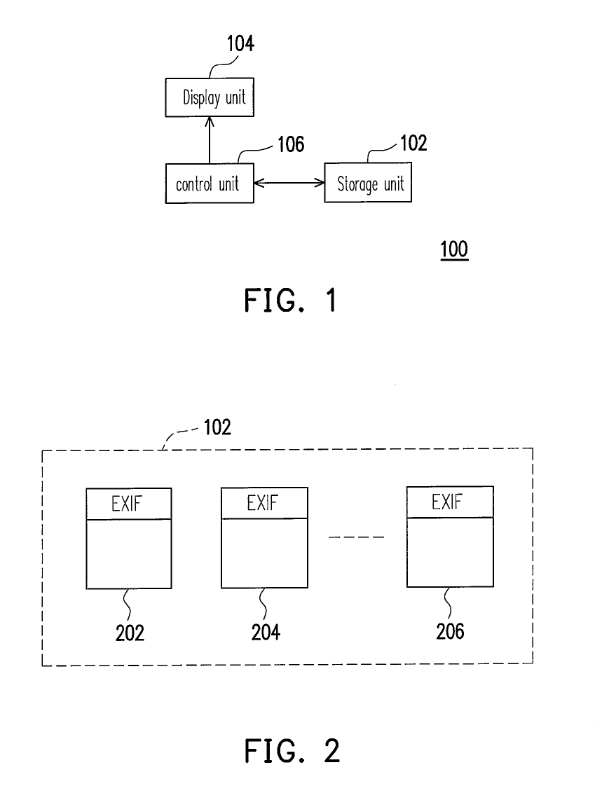

FIG. 1 is a schematic block diagram of a digital photograph display apparatus according to a first embodiment of the present invention. Referring to FIG. 1, the digital photograph display apparatus 100 provided by the present invention may be electronic apparatus such as a mobile phone, a personal digital assistant (PDA), a pocket PC (PPC), a digital camera, or a digital photo frame. The digital photograph display apparatus 100 includes a storage unit 102, a display unit 104, and a control unit 106. In the present embodiment, the control unit 106 is respectively coupled to the storage unit 102 and the display unit 104.

The storage unit 102 is a storage device, such as a hard disk (includes Solid State Drive, i.e. SSD), a flash drive (includes flash card), or a memory card. FIG. 2 is a diagram illustrating the data stored in the storage unit 102 in FIG. 1. Referring to FIG. 2, the storage unit 102 has a storage area for storing a plurality of digital photographs, such as digital photographs 202, 204, and 206. The data file of each digital photograph contains a header information. The header information is usually referred as a metadata. And the term “header” doesn't mean to limit the place where the metadata located, accessed or stored. The function of a metadata to an electronic data file (or document) is comparable to the function of a menu (or index) to a conventional printed medium data. Thus, metadata can be considered as an “electronic menu (index)”.

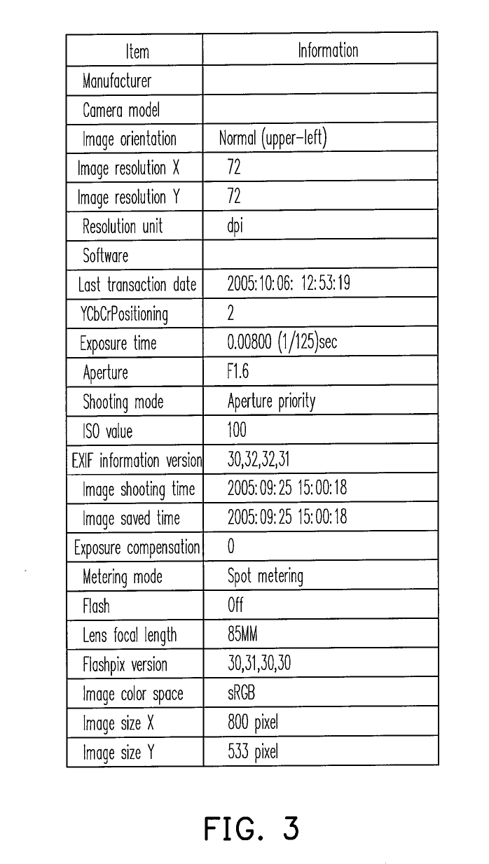

A metadata format referred as the exchangeable image file (EXIF) format is established in 1996 by Japan Electronic Industry Development Association (JEIDA). The EXIF format is especially specified for digital photographs and which records the attribute information and shooting data of digital photographs. FIG. 3 is a diagram of the EXIF format. As shown in FIG. 3, the metadata of a digital photograph contains some attribute data of the digital photograph. The information provided by a metadata is increasing along with the update of the version of the EXIF format.

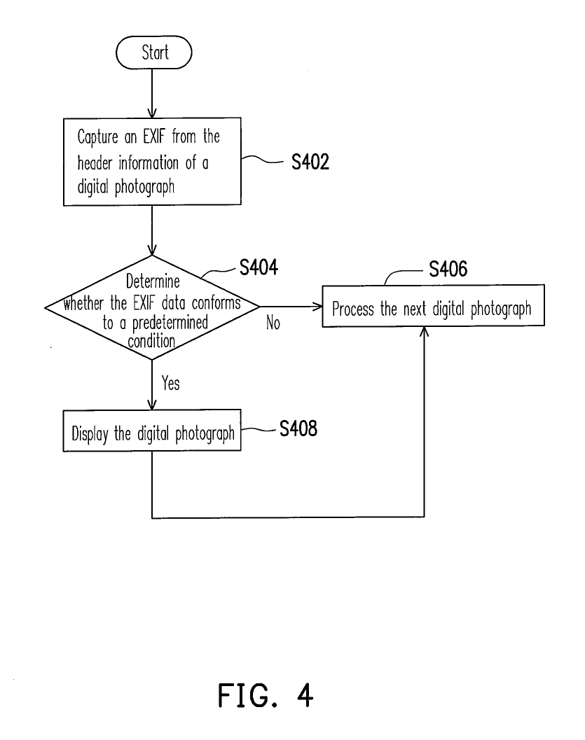

Based on foregoing description, the present invention provides a method for managing digital photographs, wherein whether the digital photographs stored in the storage unit 102 are categorized and displayed is automatically determined. FIG. 4 is a flowchart illustrating the digital photograph management method according to an embodiment of the present invention. Referring to FIGS. 1, 2, and 4, in the present embodiment, the control unit 106 captures the header information of each digital photograph in step S402, wherein the header information may be a data in foregoing EXIF format. Assuming that the control unit 106 reads the EXIF data of the digital photograph 202, step S404 is then executed to determine whether the EXIF data of the digital photograph 202 conforms to a predetermined condition.

If the EXIF data of the digital photograph 202 does not conform to the predetermined condition (as “no” in step S404), the control unit 106 processes the next digital photograph (for example, the digital photograph 204), as in step S406. Contrarily, if the EXIF data of the digital photograph 202 conforms to the predetermined condition (as “yes” in step S404), the control unit 106 automatically sets the digital photograph as a displaying digital photograph and displays the digital photograph through the display unit 104 in step S408. After that, the process goes back to step S406. In the present embodiment, the display unit 104 may be a liquid crystal display (LCD) panel. In addition, the digital photographs 202, 204, and 206 may be in bitmap file (for example, TIFF or BMP) format, Joint Photographic Experts Group (JPG) format, or graphics interchange format (GIF).

In some other embodiments of the present invention, besides determining whether to display a digital photograph according to the EXIF data thereof, the control unit 106 may also determine whether to display the digital photograph according to a keyword set by a user. If a keyword is set by the user, the control unit 106 searches whether the related information of each digital photograph contains the keyword. The control unit 106 displays a digital photograph through the display unit 104 if the related information of the digital photograph contains the keyword.

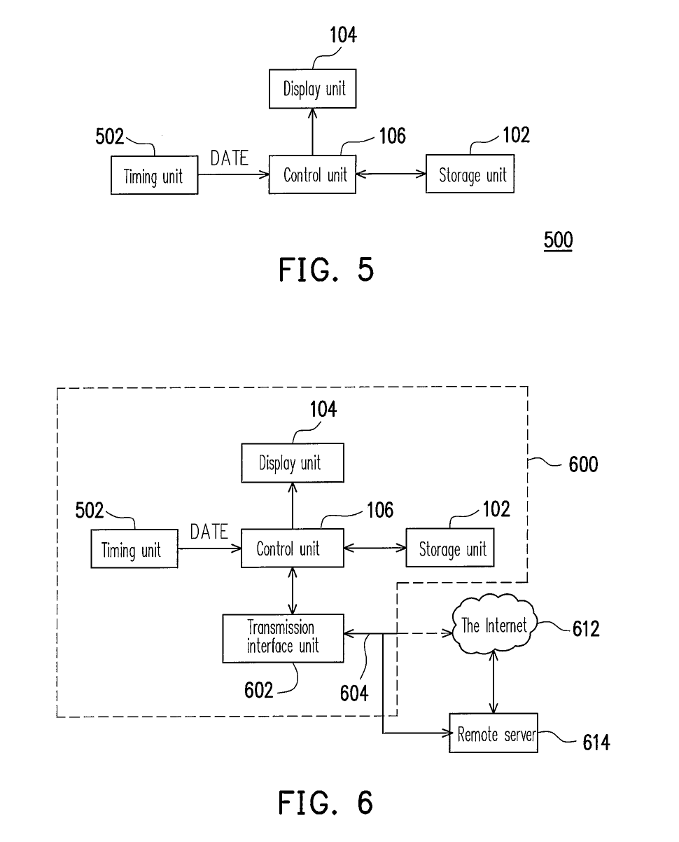

FIG. 5 is a block diagram illustrating the function of a digital photograph display apparatus according to a second embodiment of the present invention. Referring to FIG. 5, compared to the digital photograph display apparatus 100 described in the first embodiment, the digital photograph display apparatus 500 in the second embodiment further includes a timing unit 502. In the present embodiment, the timing unit 502 provides a current date information DATE to the control unit 106. The control unit 106 compares the corresponding shooting date (referring to the format illustrated in FIG. 3) of each digital photograph in the storage unit 102 with the current date information provided by the timing unit 502. The control unit 106 displays a digital photograph through the display unit 104 when the control unit 106 determines that the shooting date of the digital photograph is related to the current date information DATE.

For example, the current date information generated by the timing unit 502 is 22 Oct. 2007, and the currently processed digital photograph is taken on 22 Oct. 2000. In this case, the control unit 106 determines that the currently processed digital photograph was taken on the same date seven years ago, and accordingly the shooting date of this digital photograph is related to the current date information. Thus, the control unit 106 displays the currently processed digital photograph through the display unit 104.

As described above, assuming that the date of 22 Oct. 2007 is a special day (for example, an anniversary day) to the user, so the user may have taken many photographs on that date. If the user has taken photographs on the same date, the digital photograph display apparatus provided by the present invention displays these digital photographs having the same shooting date in the storage unit on the same date of every year. Based on foregoing description, the digital photograph display apparatus in the present embodiment can serve as an automatic digital photo frame which automatically selects and displays digital photographs. Accordingly, the product is made more interesting and the commercial value thereof is increased.

Additionally, since the digital photograph display apparatus (for example, a digital photo frame) in the present invention determines whether to display a digital photograph according to the EXIF data of the digital photograph, a user does not have to perform any other setting to the digital photograph. As a result, the convenience in using this product is greatly improved.

In some embodiments, the present invention further adjusting the digital photograph or the digital photograph display apparatus according to the metadata. For example, the position of the digital photograph in the digital photograph display apparatus can be adjusted according to the image orientation tag in EXIF drawn in FIG. 3. If the image orientation tag is a preset value, like upper-left, it is meaning that the position of the digital photograph is normal. Accordingly, if the image orientation is not the preset value, like upper-right, it is meaning that the position of the digital photograph needs to be adjusted, like horizontal rotation.

In other embodiments, the present invention is also able to adjust the setting of the digital photograph display apparatus or use a built-in (graphic processing) software for processing the digital photograph according to the exposure time tag in EXIF. For example, if the exposure time is too short, the gray scale of the photograph would be dark. At this time, the present invention is able to adjust the brightness of the digital photograph display apparatus higher, or use the built-in software to process the digital photograph automatically.

In other embodiments, the present invention may provide function corresponding to the GPS (global positioning system) tag in EXIF.

FIG. 6 is a block diagram illustrating the function of a digital photograph display apparatus according to a third embodiment of the present invention. Referring to FIG. 6, the digital photograph display apparatus 600 in the present embodiment is similar to the digital photograph display apparatus 500 described in the second embodiment for the digital photograph display apparatus 600 also includes a storage unit 102, a display unit 104, a control unit 106, and a timing unit 502. However, the digital photograph display apparatus 600 further includes a transmission interface unit 602 coupled to the control unit 106, and the transmission interface unit 602 (i.e. a transmission interface) is coupled to the Internet 612 through a data transmission path 604. The digital photograph display apparatus 600 can connect to a remote server 614 through the Internet 612. In the present embodiment, the data transmission path 604 can be established through cable transmission or wireless transmission.

Additionally, the remote server 614 may also be another storage area, such as a hard disk, a flash drive, or a memory card etc (in this case, the digital photograph display apparatus 600 can directly connect to the remote server 614 through the data transmission path 604 but not the Internet 612), for storing a plurality of digital photographs. Accordingly, the control unit 106 can automatically download suitable digital photographs from the remote server 614 based on the procedures described in the first and the second embodiment and display the digital photographs through the display unit 104.

In summary, the digital photograph display apparatus 600 provided by the present invention can not only access the local storage unit 102, but also access digital photographs stored in the remote server 614 through a data transmission path 604 and/or the Internet 612. For example, a user can upload digital photographs to an Internet blog or an online album from any network access point which can upload data to an Internet server, so that suitable digital photographs can be directly downloaded from any network access point. As a result, the function of a mobile digital photograph display apparatus is achieved. Through such a method for playing a digital photograph display apparatus, a user does not have to download the digital photographs from a remote server to edit these digital photographs before displaying them in a digital photograph display apparatus. In the present embodiment, suitable digital photographs can be directly downloaded from the Internet by the digital photograph display apparatus. Thereby, the convenience in using the product is greatly improved. Here the digital photographs may be picture data in different formats. Except EXIF, the metadata of digital photograph can also be International Press Telecommunications Council (IPTC), Extensible Metadata Platform (XMP) and so forth, and the metadata are not necessary limited to store in the header information.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for managing a digital photograph, comprising:
capturing a header information of the digital photograph;
determining whether the header information conforms to a predetermined condition; and
setting the digital photograph as a displaying digital photograph if the header information conforms to the predetermined condition.

2. The digital photograph management method according to claim 1, wherein the header information includes a metadata.

3. The digital photograph management method according to claim 2, wherein the metadata is in exchangeable image file (EXIF), International Press Telecommunication Council (IPTC) or Extensible Metadata Platform (XMP) format.

4. The digital photograph management method according to claim 1, wherein the predetermined condition is an initial shooting date related to a current date.

5. The digital photograph management method according to claim 1, wherein the digital photograph is in bitmap file format, Joint Photographic Experts Group (JPG) format, or graphics interchange format (GIF).

6. A method for playing a digital photograph display apparatus, comprising:
connecting to a storage area, wherein the storage area has a plurality of digital photographs;
comparing a header information of each of the digital photographs with a predetermined condition; and
capturing a digital photograph having the header information conforming to the predetermined condition from the storage area to be displayed.

7. The method according to claim 6, wherein the header information includes a metadata.

8. The method according to claim 7, wherein the metadata is in EXIF, IPTC or XMP format.

9. The method according to claim 7, wherein the step of comparing the header information of each of the digital photographs with the predetermined condition comprises:
generating a current date information;
reading a corresponding shooting date from the metadata of each of the digital photographs;
comparing the corresponding shooting date of each of the digital photographs with the current date information;
determining that the currently compared digital photograph conforms to the predetermined condition if the shooting date of the currently compared digital photograph is related to the current date information; and
determining that the currently compared digital photograph does not conform to the predetermined condition if the shooting date of the currently compared digital photograph is not related to the current date information.

10. The method according to claim 6, wherein the storage area is a storage apparatus.

11. The method according to claim 10, wherein the storage apparatus comprises a hard disk, a flash drive, and a memory card.

12. The method according to claim 6, wherein the storage area is a remote server.

13. The method according to claim 12, wherein the step of capturing the digital photograph from the storage area comprises capturing the digital photograph from the remote server through cable transmission or wireless transmission.

14. The method according to claim 6 further comprising:
setting a keyword;
searching whether the content of each of the digital photographs comprises the keyword; and
displaying the currently searched digital photograph if the content of the currently detected digital photograph comprises the keyword.

15. The method according to claim 6, wherein the digital photograph display apparatus comprises a mobile phone, a personal digital assistant (PDA), a pocket PC (PPC), a digital camera, and a digital frame.

16. A digital photograph display apparatus, comprising:
a storage unit, for storing a plurality of digital photographs;
a display unit, for displaying images;
a control unit, coupled to the storage unit and the display unit for capturing a header information of each of the digital photographs and displaying the digital photograph through the display unit, if the header information of the digital photograph conforms to a predetermined condition.

17. The digital photograph display apparatus according to claim 16, wherein the header information includes a metadata.

18. The digital photograph display apparatus according to claim 17, wherein the metadata is in EXIF, IPTC or XMP format.

19. The digital photograph display apparatus according to claim 16 further comprising a timing unit for generating a current date information.

20. The digital photograph display apparatus according to claim 19, wherein the control unit compares a corresponding shooting date of each of the digital photographs with the current date information and displays the digital photograph through the display unit if the shooting date of the digital photograph is related to the current date information.

21. The digital photograph display apparatus according to claim 16 further comprising a transmission interface unit for connecting the control unit to a remote server through a data transmission path, wherein the remote server stores a plurality of digital photographs, and the control unit downloads the digital photographs having the header information thereof conforming to the predetermined condition from the remote server and displays the digital photographs through the display unit.

22. The digital photograph display apparatus according to claim 21, wherein the data transmission path is a cable transmission path or a wireless transmission path.

23. The digital photograph display apparatus according to claim 21, wherein the data transmission path is connected to the remote server through the Internet.

24. The digital photograph display apparatus according to claim 21, wherein the remote server is a storage apparatus.

25. The digital photograph display apparatus according to claim 16, wherein the display unit is a liquid crystal display (LCD) panel.
